(19) United States
(12) Patent Application Publication
(10) Pub. No.: US 2018/0204575 A1
(43) Pub. Date: Jul. 19, 2018

(54) CONTROL SYSTEM UTILIZING VERBAL COMMAND

(71) Applicant: FOXCONN INTERCONNECT TECHNOLOGY LIMITED, Grand Cayman (KY)

(72) Inventor: MING-CHIEH HUANG, New Taipei (TW)

(21) Appl. No.: 15/870,872

(22) Filed: Jan. 13, 2018

(30) Foreign Application Priority Data
Jan. 14, 2017 (CN) 201710026540.0

(51) Int. Cl. G10L 15/30; G10L 15/01; H04N 21/422

(52) U.S. Cl. CPC G10L 15/30; G10L 15/01; G10L 2015/223; H04N 21/42203; H04N 21/42222

(57) ABSTRACT

A verbal control system includes a plurality of switches and a mobile device wirelessly connected with one another wherein each switch may control the corresponding equipments, respectively. Those switches are connected with one another via a wireless mesh network. Each switch is equipped with a speaker and a microphone. When the user says the verbal command to any switch, such a specific/local switch obtains the command through its own microphone and transfer such a command to another specific/intermediate switch which is relatively far from the local switch while being closest to the mobile device. The intermediate switch sends the verbal command to the mobile device via its own speaker.

### 1. FIELD OF THE DISCLOSURE

The invention is related to a control system, and particularly to the control system utilizing verbal command without the corresponding mobile device in hand.

### 2. DESCRIPTION OF RELATED ARTS

The intelligent home arrangement may be activate verbally. The user may use the mobile device to activate the equipments even if he is not at the spot. Anyhow, such a mobile device should be with the user constantly.

Therefore, it is desired to have an improvement verbal control system which does not require the mobile device personally brought by the user.

### SUMMARY OF THE DISCLOSURE

An object of the invention is to provide a verbal control system without requiring the user to bring the mobile device while being able to transfer, via the wireless mesh network instead, the verbal command to the mobile device for completing the commanding process. A verbal control system includes a plurality of switches and a mobile device wirelessly connected with one another wherein each switch may control the corresponding equipments, respectively. Those switches are connected with one another via a wireless mesh network. Each switch is equipped with a speaker and a microphone. When the user says the verbal command to any switch, such a specific/local switch obtains the command through its own microphone and transfer such a command to another specific/intermediate switch which is relatively far from the local switch while being closest to the mobile device. The intermediate switch sends the verbal command to the mobile device via its own speaker. Therefore, the mobile device executes the command through the Internet to activate the specific/target switch for operating the specific equipment controlled by the target switch.

### BRIEF DESCRIPTION OF THE DRAWINGS

FIG. 1 is a flow chart showing the verbal control system,

### DETAILED DESCRIPTION OF THE PREFERRED EMBODIMENT

Reference will now be made in detail to the embodiments of the present disclosure. A verbal control system includes a plurality of switches and a mobile device running within a wireless mesh network in addition to the Internet. The switches control the corresponding equipments, respectively. The switches are connected via the wire mesh network. Each of the switches is equipped with a microphone and a speaker. The mobile device is connected to the Internet via Wi-Fi. The user says the command verbally to the corresponding microphone of any local switch. Such a verbal command is transferred, via the wireless mesh network, to an intermediate switch which is closest/closer to or within the reasonable voice approachable range of the mobile device. Such an intermediate switch sends the command to the mobile device via the corresponding speaker. The mobile device sends the command to the server via the Internet to activate the corresponding switch for operating the corresponding equipment.

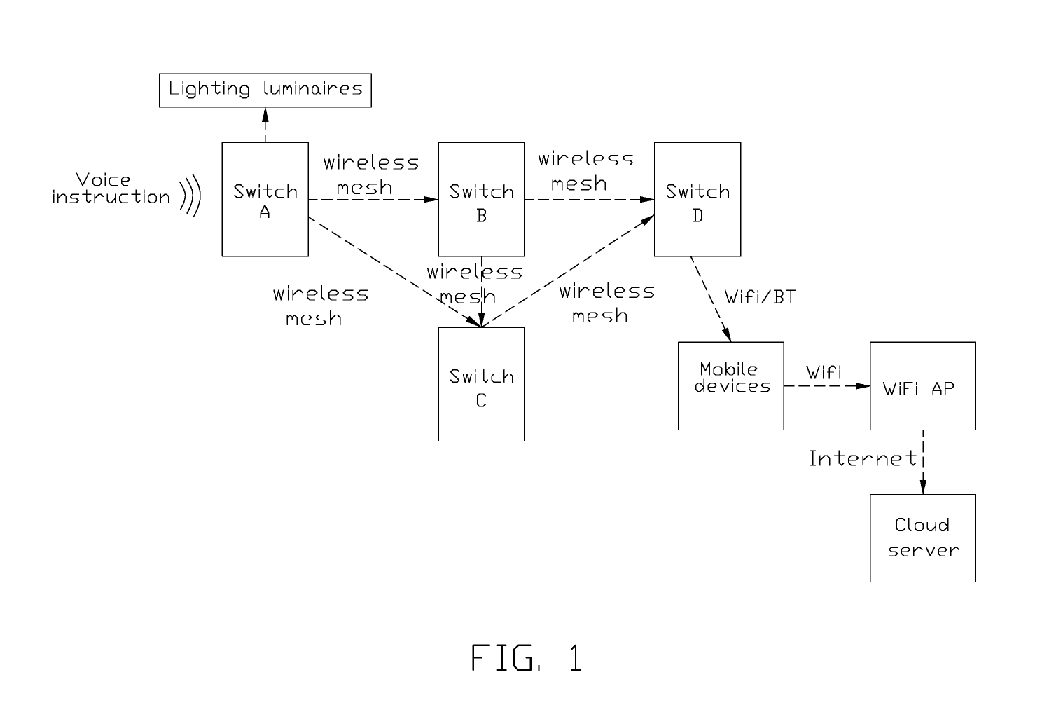

Referring to FIG. 1, the verbal control system includes switches A, B, C and D respectively located at different positions/rooms and linked with one another in a wireless mesh network. Each switch A,B, C and D controls the respective equipment. In this embodiment, the mobile device is linked wirelessly with the switches via Wi-Fi Blue Tooth and is capable of identifying the closest switch thereabouts and connected thereto in the wireless mesh network, i.e., the switch D. A Wi-Fi AP (Access Point), e.g., the wireless router or the wireless hot spot, provides send and receiving of the wireless signal. So the mobile device sends the command to the cloud server via the Wi-Fi AP.

When the user likes to operate the local switch A and gives the verbal command to the local switch A, i.e., the local switch closest to the user, the switch A receives the command via the microphone and transfers/forwards, via the wireless mesh network, the command to the intermediate switch D which is identified, by the mobile device, to be the closest one to the mobile device. The switch D sends the command to the mobile device via the corresponding speaker. The mobile device sends, via Wi-Fi AP and the Internet, the command to the cloud server. The cloud server executes the command to operate the target switch A.

In this embodiment, the switch A not only receives the verbal command but also is activated to operate the corresponding equipment according to the verbal command even if the mobile device is not around the switch A. In other words, the switch A is not only the so-called local switch for receiving the verbal command but also the target switch for executing the verbal command. Notably, it is also allowable to give the verbal command to the switch A for activating other switches to operate other equipments. On the other hand, the intermediate switch may be also either the local switch or the target switch.

In brief, the traditional control system requires to use the mobile device receiving the verbal command locally for controlling the remote switches. In opposite, in the instant invention the verbal control system may be implemented even if the mobile device is not accompanied by the user.

While a preferred embodiment according to the present disclosure has been shown and described, equivalent modifications and changes known to persons skilled in the art according to the spirit of the present disclosure are considered within the scope of the present disclosure as described in the appended claims.

What is claimed is:

1. A verbal control system comprising:
a plurality of switches used for operating a plurality of equipments, respectively, and linked with one another via a wireless mesh network, each of said switches including a microphone and a speaker and being capable of operating an equipment; and
a mobile device linked to the switches wirelessly and being capable of identifying the closest one of the switches thereto; wherein
when a user verbally gives a command related to activation of at least a target one of the plurality of switches for operating the corresponding equipment to a local switch of the plurality of switches which is a closest one to the user, the local switch receives the command via the corresponding microphone and transfers the command, via the wireless mesh network, to an intermediate switch of the plurality of switches which is identified by the mobile device as the closest one thereto, and the intermediate switch verbally gives the command to the mobile device by the corresponding speaker.

2. The verbal control system as claimed in claim 1, wherein the mobile device is wirelessly connected to a cloud sever through Internet.

3. The verbal control system as claimed in claim 2, wherein the mobile device is wirelessly connected to the Internet through Wi-Fi.

4. The verbal control system as claimed in claim 3, wherein the mobile device and the switches are connected wirelessly.

5. The verbal control system as claimed in claim 4, wherein the mobile device and the switches are connected via Wi-Fi.

6. The verbal control system as claimed in claim 2, wherein the cloud sever has the corresponding target switch execute the command.

7. The verbal control system as claimed in claim 1, wherein all the local switch, the intermediate switch and the target switch are different from one another.

8. The verbal control system as claimed in claim 1, wherein at least two of said local switch, the intermediate switch and the target switch are of the same one.

9. A method of implementing a verbal control system, comprising steps of;
providing a plurality of switches with connection in a wireless mesh network;
providing each of said switch with a speaker and a microphone and with a function to operate an equipment; and
providing a mobile device with connection to the switches wirelessly;
wherein
a local switch of said plurality of switches a user is close to, receives a verbal command regarding activating a target switch of said plurality of switches to operate the corresponding equipment via the microphone and transfers the command to an intermediate switch of said plurality of switches a mobile device is close to, and eventually to the mobile device via the speaker of the intermediate switch.

10. The method as claimed in claim 9, further providing a Wi-Fi AP to receive the command from the mobile device to the Internet.

11. The method as claimed in claim 10, further providing a cloud sever linked to the Internet to receive the command and execute the command by activating said target switch of said plurality of switches.

12. The method as claimed in claim 9, wherein the mobile device communicates with the switches via Wi-Fi Blue Tooth.

13. The method as claimed in claim 9, wherein all the local switch, the intermediate switch and the target switch are different from one another.

14. The method as claimed in claim 9, wherein at least two of the local switch, the intermediate switch and the target switch are of the same one.

15. A verbal control system comprising:
a switch used within a wireless mesh network with other same type switches while activating different equipments, including a microphone and a speaker; and
a mobile device communicates with all switches via Wi-Fi Blue Tooth;
wherein
a verbal command from a local switch in the wireless mesh network closer to a user via the microphone of the local switch can be passed to an intermediate switch in the wireless mesh network closer to the mobile device via the wireless mesh network, and further transferred to the mobile device via the speaker of the intermediate switch.

16. The verbal control system as claimed in claim 15, further including a cloud server receiving the command from the mobile device via Internet.

17. The verbal control system as claimed in claim 16, wherein the mobile device is wirelessly connected to the Internet via Wi-Fi.

18. The verbal control system as claimed in claim 15, wherein the mobile device has capability of identifying the specific switch in the wireless mesh network closest thereto.

19. The verbal control system as claimed in claim 15, where said command is regarding activation of a target switch in the wireless mesh network for operating the corresponding equipment.
